(19) United States
(12) Patent Application Publication
(10) Pub. No.: US 2011/0197075 A1
(43) Pub. Date: Aug. 11, 2011

(54) ELECTRONIC DEVICE AND POWER ADAPTER THEREOF AND METHOD FOR IDENTIFYING POWER ADAPTER

(75) Inventors: PING-CHENG HSIEH, Guishan (TW); CHUNG-YI TSAI, Guishan (TW)

(73) Assignee: EVER LIGHT TECHNOLOGY LIMITED, Taoyuan County (TW)

(21) Appl. No.: 12/838,472

(22) Filed: Jul. 18, 2010

(30) Foreign Application Priority Data
Feb. 5, 2010 (TW) 99103442

(51) Int. Cl. G06F 21/02; G06F 1/26; H04L 9/06; G06F 7/04

(52) U.S. Cl. 713/189; 340/5.8; 713/300; 380/44

(57) ABSTRACT

An electronic device includes a detection module, an identification code generation module, a decryption module, a comparison module, and a control module. The detection module transmits a detection signal after detecting that a power adapter is connected to the electronic device. The identification code generation module randomly generates an encrypted identification code after receiving the detection signal. The decryption module decrypts the identification code to generate a first decryption code. The comparison module compares a second decryption code that has been fed back from the power adapter after the power adapter receiving the detection signal, with the first decryption code. The control module controls the electronic device to receive power from the power adapter when the first decryption code is the same as the second decryption code.

### BACKGROUND

1. Technical Field

The present disclosure relates to electronic devices and methods, and particularly to a method for identifying a power adapter.

2. Description of Related Art

As demand for electronic devices, such as notebook computers, mobile phones, and personal digital assistants, is increasing, power adapters supplying power to the electronic devices become the key for many retailers to obtain profit by selling fake or replicated knock-offs as original brand name products. Therefore, all kinds of non-original power adapters emerge in the market. However, different power adapters may have different current, voltage, and other power related requirements established to match their original electronic devices. If a non-original power adapter does not match power requirements of an electronic device, the electronic device may become unstable, and may even cause a battery to explode.

### BRIEF DESCRIPTION OF THE DRAWINGS

Many aspects of the present embodiments may be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the views.

FIG. 1 is a schematic diagram of an exemplary embodiment of an electronic device and a power adapter connected to the electronic device.

FIG. 2 is a block diagram of the electronic device and the power adapter of FIG. 1.

FIG. 3 is a flowchart of an exemplary embodiment of a method for identifying whether the power adapter is the authentic power adapter of the electronic device of FIG. 1.

### DETAILED DESCRIPTION

The disclosure, including the accompanying drawings in which like references indicate similar elements is illustrated by way of example and not by way of limitation. It should be noted that references to “an” or “one” embodiment in this disclosure are not necessarily to the same embodiment, and such references mean at least one.

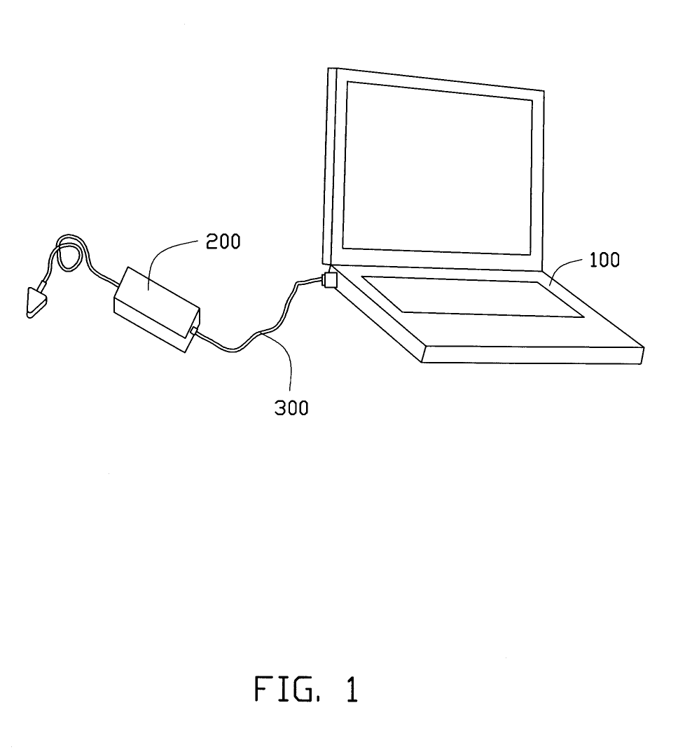

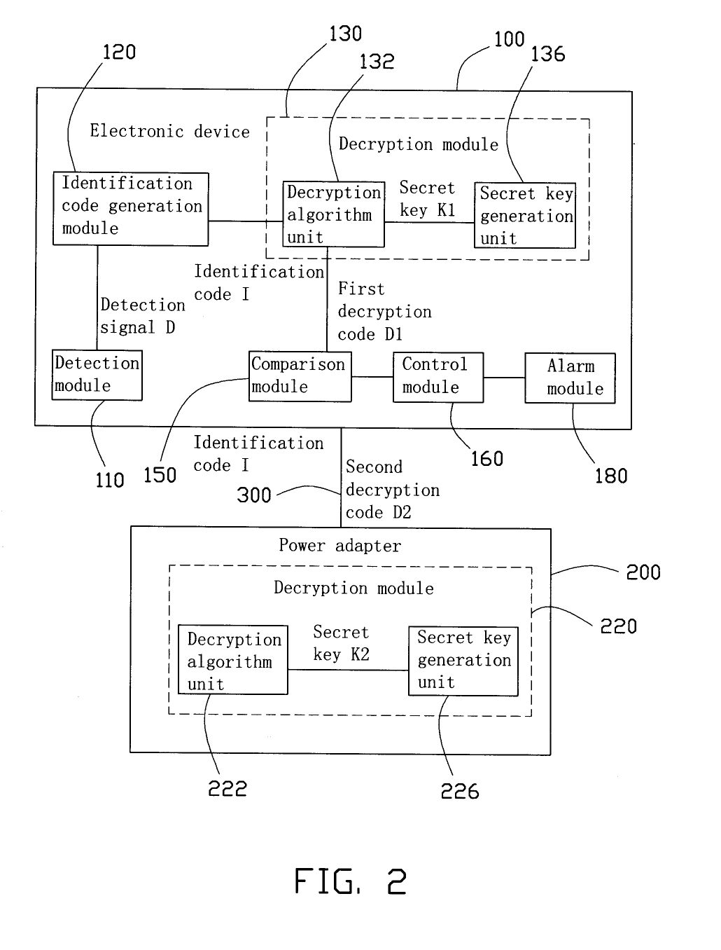

Referring to FIGS. 1 and 2, an exemplary embodiment of an electronic device 100 includes a detection module 110, an identification code generation module 120, a decryption module 130, a comparison module 150, a control module 160, and an alarm module 180. The decryption module 130 includes a decryption algorithm unit 132 and a secret key generation unit 136. In one embodiment, the electronic device 100 may be a portable electronic device, such as a notebook computer, a mobile phone, a camera, a handheld game console, or a personal digital assistant. The electronic device 100 can identify whether a power adapter connected to the electronic device 100 is its authentic power adapter, and only receives power from the authentic power adapter.

An exemplary embodiment of a power adapter 200 includes a decryption module 220. The decryption module 220 includes a decryption algorithm unit 222 and a secret key generation unit 222. In one embodiment, the power adapter 200 is connected to the electronic device 100 by a cable 300.

In operation, the detection module 110 transmits a detection signal D to the identification code generation module 120, after detecting that the power adapter 200 is connected to the electronic device 100. The identification code generation module 120 randomly generates an encrypted identification code I after receiving the detection signal D, and transmits the identification code I to the decryption module 130 of the electronic device 100 and the decryption module 220 of the power adapter 200. The decryption module 130 decrypts the identification code I and a secret key K1 generated by the secret key generation unit 136, by an irreversible cryptographic algorithm in the decryption algorithm unit 132, to generate a first decryption code D1, and sends the first decryption code D1 to the comparison module 150. The decryption module 220 decrypts the identification code I and a secret key K2 generated by the secret key generation unit 226, by an irreversible cryptographic algorithm in the decryption algorithm unit 222, to generate a second decryption code D2, and sends the second decryption code D2 to the comparison module 150. The comparison module 150 compares the first decryption code D1 with the second decryption code D2, and transmits the results to the control module 160. The control module 160 determines whether to receive power from the power adapter 200, and whether to turn on the alarm module 180, according to the compared results.

If the compared result is that the first decryption code D1 is the same as the second decryption code D2, which indicates that the power adapter 200 is an authentic power adapter of the electronic device 100, the control module 160 allows the electronic device 100 to receive power from the power adapter 200. If the compared result is that the first decryption code D1 is different from the second decryption code D2, which indicates that the power adapter 200 is not an authentic power adapter of the electronic device 100, the control module 160 prevents the electronic device 100 from receiving power from the power adapter 200, and activates the alarm module 180 to sound an alarm. In one embodiment, the alarm module 180 may includes a light-emitting diode, a buzzer, and/or a monitor indication.

In this embodiment, the power adapter 200 is an authentic power adapter of the electronic device 100. The decryption module 130 is the same as the decryption module 220, the decryption algorithm unit 132 is the same as the decryption algorithm unit 222, the secret key generation unit 136 is the same as the secret key generation unit 226, the secret key K1 is predetermined to be the same as the secret key K2, and the irreversible cryptographic algorithm adopted by the decryption algorithm unit 132 is predetermined to be the same as the irreversible cryptographic algorithm adopted by the decryption algorithm unit 222. Therefore, the first decryption code D1 generated by processing the identification code I in the decryption module 130 is the same as the second decryption code D2 generated by processing the identification code I in the decryption module 220.

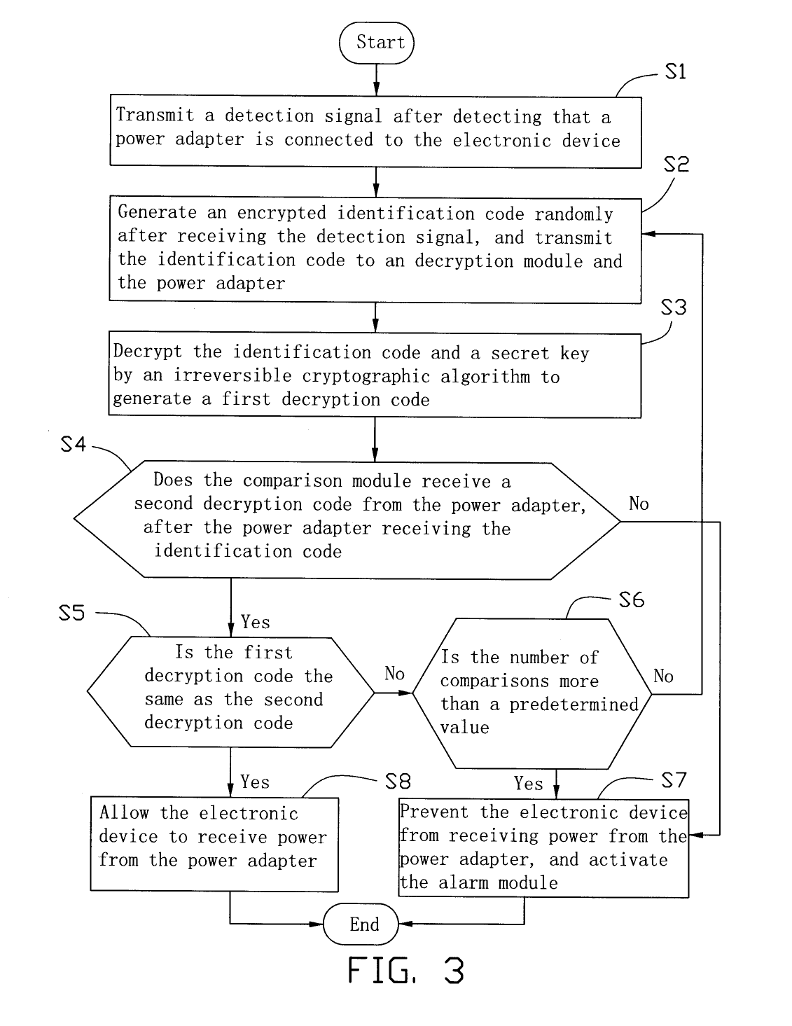

Referring to FIG. 3, an exemplary embodiment of a method for identifying whether the power adapter 200 is an authentic power adapter of the electronic device 100, includes the following steps.

In step S1: the detection module 110 transmits a detection signal D to the identification code generation module 120, after detecting that the power adapter 200 is connected to the electronic device 100.

In step S2: the identification code generation module 120 randomly generates an encrypted identification code I after receiving the detection signal D, and transmits the identification code I to the decryption module 130 and the power adapter 200.

In step S3: the decryption module 130 decrypts the identification code I and a secret key K1 generated by the secret key generation unit 136, by an irreversible cryptographic algorithm in the decryption algorithm unit 132, to generate a first decryption code D1, and sends the first decryption code D1 to the comparison module 150.

In step S4: while the comparison module 150 determines whether it receives a second decryption code D2 from the power adapter 200 after the power adapter 200 receives the identification code I, there is a time delay. If the comparison module 150 receives the second decryption code D2 within the time delay, step S5 is implemented. If the comparison module 150 does not receive the second decryption code D2 within the time delay, step S7 is implemented. The time delay is equal to the time that is needed by the decryption module 130 to generate the first decryption code D1. If the power adapter 200 is the authentic power adapter of the electronic device 100, the time needed by the decryption module 220 to generate the second decryption code D2 is equal to the time needed by the decryption module 130 to generate the first decryption code D1. In one embodiment, the time delay is no more than 100 milliseconds. In other embodiments, the time delay may be adjusted according to actual need.

In step S5: the comparison module 150 compares the first decryption code D1 with the second decryption code D2, and updates the number of comparisons stored in the comparison module 150. If the first decryption code D1 is different from the second decryption code D2, step S6 is implemented. If the first decryption code D1 is the same as the second decryption code D2, step S8 is implemented.

In step S6: the comparison module 150 determines whether the number of comparisons is more than a predetermined value N. If the number of comparisons is more than the predetermined value N, step S7 is implemented. If the number of comparisons is no more than the predetermined value N, step S2 is repeated. In this embodiment, in order to avoid some accidents leading to the first decryption code D1 being different from the second decryption code D2, and thereby affecting identification results, a step of determining whether the number of comparisons is more than a predetermined value N is needed, and value of the predetermined value N is equal to 10. In other embodiments, the value of the predetermined value N may be adjusted according to actual need, and the step of determining whether the number of comparisons is more than a predetermined value N may also be omitted.

In step S7: the control module 160 prevents the electronic device 100 from receiving power from the power adapter 200, and activates the alarm module 180 to warn that the power adapter 200 is not the authentic power adapter of the electronic device 100.

In step S8: the control module 160 allows the electronic device 100 to receive power from the power adapter 200.

As detailed above, due to the encrypted identification code I is generated in the identification code generation module 120 randomly and the irreversible cryptographic algorithm is not reversible, the secret keys K1 and K2 can not be derived from the encrypted identification code I and the second decryption code D2 intercepted from the cable 300 by special equipment, therefore, the authentic power adapter 200 can not be substituted with fake or replicated knock-off products. Further, the electronic device 100 indentifies each power adapter 200 connected to the electronic device 100, and only receives power from authentic power adapters 200, ensuring that the power adapter 200 is authentic. Therefore, the instability, security and safety concerns of the electronic device 200 can be eliminated.

The foregoing description of the exemplary embodiments of the disclosure has been presented only for the purposes of illustration and description and is not intended to be exhaustive or to limit the disclosure to the precise forms disclosed. Many modifications and variations are possible in light of the above embodiments. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An electronic device comprising:
a detection module operable to transmit a detection signal, in response to detecting that a power adapter is connected to the electronic device;
an identification code generation module operable to randomly generate an encrypted identification code, in response to receiving the detection signal;
a decryption module operable to decrypt the identification code received from the identification code generation module, to generate a first decryption code;
a comparison module operable to compare the first decryption code received from the decryption module with a second decryption code that has been fed back from the power adapter, wherein the power adapter generates the second decryption code, in response to receiving the identification code from the identification code generation module; and
a control module operable to control the electronic device to receive power from the power adapter, in response to the first decryption code being the same as the second decryption code.

2. The electronic device of claim 1, wherein the decryption module comprises a decryption algorithm unit and a secret key generation unit, the secret key generation unit is operable to generate a secret key, the decryption algorithm unit is operable to decrypt the identification code and the secret key to generate the first decryption code.

3. The electronic device of claim 2, wherein the decryption algorithm unit decrypts the identification code and the secret key by an irreversible cryptographic algorithm to generate the first decryption code.

4. The electronic device of claim 1, further comprising an alarm module controlled by the control module, wherein in response to the first decryption code being different from the second decryption code, the control module controls the electronic device not to receive power from the power adapter, and activates the alarm module.

5. A power adapter for supplying power to an electronic device, the power adapter comprising:
a decryption module operable to decrypt an identification code received from the electronic device to generate a first decryption code, and operable to transmit the first decryption code to the electronic device;
wherein the first decryption code is compared with a second decryption code generated by the electronic device by decrypting the identification code, and in response to the first decryption code being the same as the second decryption code, power supplied by the power adapter is received by the electronic device.

6. The power adapter of claim 5, wherein the decryption module comprises a decryption algorithm unit and a secret key generation unit, the secret key generation unit is operable to generate a secret key, the decryption algorithm unit is operable to decrypt the identification code and the secret key to generate the first decryption code.

7. The power adapter of claim 6, wherein the decryption algorithm unit decrypts the identification code and the secret key by an irreversible cryptographic algorithm to generate the first decryption code.

8. A method for identifying whether a power adapter connected to an electronic device is an authentic power adapter of the electronic device, the method comprising:
transmitting a detection signal in response to detecting that the power adapter is connected to the electronic device;
generating an encrypted identification code randomly in response to receiving the detection signal;
decrypting the identification code received from the identification code generation module to generate a first decryption code;
comparing the first decryption code received from the decryption module with a second decryption code that has been fed back from the power adapter, wherein the power adapter generates the second decryption code, in response to receiving the identification code from the identification code generation module; and
controlling the electronic device to receive power from the power adapter, in response to the first decryption code being the same as the second decryption code.

9. The method of claim 8, further comprising controlling the electronic device not to receive power from the power adapter, and activating an alarm module of the electronic device, in response to the first decryption code being different from the second decryption code.
